(19) United States
(12) Patent Application Publication
(10) Pub. No.: US 2002/0040922 A1
(43) Pub. Date: Apr. 11, 2002

(54) Multi-modal soldering inspection system

(76) Inventor: Shigeki Kobayashi, Kyoto-shi (JP)

Correspondence Address: SMITH, GAMBRELL & RUSSELL, LLP, 1850 M STREET, N.W., SUITE 800, WASHINGTON, DC, 20036, US

(21) Appl. No.: 09/886,470

(22) Filed: Jun. 22, 2001

(30) Foreign Application Priority Data
Jun. 22, 2000 (JP) 2000/187252

(51) Int. Cl. B23K 13/08; B23K 15/02

(52) U.S. Cl. 228/9; 228/8; 228/105

(57) ABSTRACT

Multi-modal soldering inspection system comprises means for automatic inspection involving imaging means for acquiring solder joint images, mode-selecting means for selecting auto mode, review mode, or eye mode, means for integrating inspection data obtained in the auto and the review modes, replay means for replaying images acquired with the imaging means to display them, input means for inputting the review data, and storage for storing the inspection data.

The multi-modal soldering inspection system works in two or three modes wherein, at first in the auto mode, the system performs automatic inspection of solder joints of a printed circuit board (PCB) and stores addresses and/or images of suspect points tentatively judged as defective in the automatic inspection, next in the review mode, the system reacquires or replays images of the suspect points to display them with markers superimposed thereon so that an operator can carry out the verification by looking at the displayed images, and finally in the eye mode, the system displays a PCB map indicating addresses of points for visual inspection so that an operator can carry out direct visual inspection of the PCB referring to the map and accomplish the total inspection by inputting the visual inspection data.

### BACKGROUND OF THE INVENTION

The instant invention relates to a multi-modal system for solder joint inspection of a printed circuit board (PCB) packaged with electronic parts. The system works not only in auto mode for automatic inspection but also in review mode for verification of the auto mode data, which can be followed by additional eye mode for direct visual inspection by humans.

Visual inspection of electronic products has been done with naked eyes or using a stereoscopic microscope, but with advanced miniaturization of parts, human inspection has become increasingly more difficult and more unreliable.

Hence, demands for the automation have emerged nowadays to raise reliability and to save human cost.

Many kinds of apparatuses for automatic soldering inspection of electronic parts on PCBs have been developed and already used in assembly lines.

However, they had still problems mainly in their cost-performance.

They were expensive as compared with their ability of saving human cost.

Users often requested perfect performance in automation where correlation between automatic inspection and human discrimination marks a hundred percent coincidence. Makers also often tried to attain it by making long-term, consuming efforts of highly-skilled and high-cost engineers.

Because improvement of the recognition capability might require from several days to several months the length of which depends upon user's production environment, the machine prices became more expensive.

Makers could not neglect the risk of increasing costs.

In a matter of fact, a human brain recognizes an object in a way quite different from that of a computer.

There is no causality between them, so a confusion matrix in-between expresses only their statistical correlation.

From a theoretical point of view, a hundred percent coincidence could never be obtained and fine tuning of computer parameters for recognition intending to attain it will necessarily fail.

From reasons mentioned above, the embodiments of the present invention intend to solve the problem of recognition in the conventional automatic soldering inspection machines by presenting a system where no perfect coincidence of recognition is demanded.

### OBJECTS OF THE INVENTIONS

An object of the present invention is to provide a multi-modal soldering inspection system which works in two modes wherein, in auto mode, the system performs automatic inspection of solder joints of a printed circuit board (PCB) and stores addresses of suspect points which have been tentatively judged as defective in the automatic inspection and, in review mode, the system reacquires images of the suspect points and display them with markers superimposed thereon so that an operator can carry out the verification by looking at the displayed images and accomplish the total inspection by inputting the reviewed data.

Another object of the present invention is to provide a multi-modal soldering inspection system which works in two modes wherein, in auto mode, the system performs automatic inspection of solder joints of a PCB and stores images and addresses of suspect points which have been tentatively judged as defective in the automatic inspection and, in review mode, the system replays the stored images and display them with markers superimposed thereon so that an operator can carry out the verification by looking at the displayed images and accomplish the total inspection by inputting the reviewed data.

Yet another object of the present invention is to provide a multi-modal soldering inspection system which works in three modes wherein, in auto mode, the system performs automatic inspection of solder joints of a PCB and stores images and addresses of suspect points which have been tentatively judged as defective in the automatic inspection, in review mode, the system replays images of the suspect points and display them with markers superimposed thereon so that an operator can carry out the verification by looking at the images and input the reviewed data, and, in eye mode, the system displays a PCB map indicating addresses of points for visual inspection so that an operator can carry out direct visual inspection of the PCB referring to the map and accomplish the total inspection by inputting the visual inspection data.

### SUMMARY OF THE INVENTION

In accordance with a feature of the present invention, a multi-modal soldering inspection system comprises means for automatic inspection involving imaging means for imaging solder joints, mode-selecting means for selecting auto mode or review mode, means for integrating inspection data obtained in the auto and the review modes, storage for storing the inspection data, display means for displaying images reacquired with the imaging means, and input means for inputting the reviewed data, enabling dual mode inspection consisting of auto mode performing automatic inspection of solder joints of a printed circuit board (PCB) and review mode reacquiring images of the suspect points which has been judged tentatively in the auto mode as fault soldering and displaying them so that an operator can carry out the verification and accomplish the total inspection by inputting the reviewed data.

In accordance with another feature of the present invention, a multi-modal soldering inspection system comprises means for automatic inspection involving imaging means for imaging solder joints, mode-selecting means for selecting auto mode or review mode, means for integrating inspection data obtained in the auto and the review modes, storage for storing the inspection data, replay means for replaying images stored with the storage and displaying them, and input means for inputting the reviewed data, enabling dual mode inspection consisting of auto mode performing automatic inspection of solder joints of a PCB and storing images of suspect points which has been judged tentatively in the auto mode as fault soldering and review mode replaying the stored images and displaying them so that an operator can carry out the verification and accomplish the total inspection by inputting the reviewed data.

In accordance with yet another feature of the present invention, a multi-modal soldering inspection system comprises means for automatic inspection involving imaging means for imaging solder joints, mode-selecting means for selecting auto mode, review mode, or eye mode, means for integrating inspection data obtained in the auto and the review modes, storage for storing the inspection data, replay means for replaying images stored with the storage and displaying them, and input means for inputting the reviewed data and the visual inspection data, enabling triple mode inspection consisting of auto mode performing automatic inspection of solder joints of a PCB and storing images of suspect points which has been judged tentatively in the auto mode as fault soldering, review mode replaying the stored images and displaying them so that an operator can carry out the verification, and eye mode displaying a PCB map indicating addresses of points for visual inspection so that an operator can carry out direct visual inspection of the PCB referring to the map and accomplish the total inspection by inputting the visual inspection data.

### BRIEF DESCRIPTION OF THE DRAWINGS

FIG. 1 illustrates schematically optical constitution of an active vision system involved in a multi-modal soldering inspection system of an embodiment of the present invention.

FIG. 2 is a diagram showing geometrical relationships between the visual axis of the active vision system and an object for inspection involved in a multi-modal soldering inspection system of an embodiment of the present invention.

FIG. 3 is a schematic diagram showing system constitution and horizontally turned poses of a PCB involved in a multi-modal soldering inspection system of an embodiment of the present invention.

FIG. 4 is a flow diagram showing steps of teaching involved in a multi-modal soldering inspection system of an embodiment of the present invention.

FIG. 5 is a flow diagram showing steps of auto mode inspection involved in a multi-modal soldering inspection system of an embodiment of the present invention.

FIG. 6 is a flow diagram showing steps of review mode inspection involved in a multi-modal soldering inspection system of an embodiment of the present invention.

FIG. 7 is a schematic diagram showing system constitution involved in a multi-modal soldering inspection system of second embodiment of the present invention.

FIG. 8 is a flow diagram showing steps of auto mode inspection and review mode inspection involved in a multi-modal soldering inspection system of second embodiment of the present invention.

FIG. 9 is a flow diagram showing steps of auto mode inspection and review mode inspection involved in a multi-modal soldering inspection system of third embodiment of the present invention.

FIG. 10 is a flow diagram showing steps of teaching involved in a multi-modal soldering inspection system of fourth embodiment of the present invention.

FIG. 11 is a flow diagram showing steps of auto mode inspection, review mode inspection, and eye mode inspection involved in a multi-modal soldering inspection system of fourth embodiment of the present invention.

FIG. 12 is a flow diagram showing steps of teaching involved in a multi-modal soldering inspection system of fifth embodiment of the present invention.

FIG. 13 is a flow diagram showing steps of auto mode inspection, review mode inspection, and eye mode inspection involved in a multi-modal soldering inspection system of fifth embodiment of the present invention.

FIG. 14 illustrates schematically sequential display and multiple-frame display of suspect images in review mode in a multi-modal soldering inspection system of sixth embodiment of the present invention.

FIG. 15 is a schematic diagram showing system constitution involved in a multi-modal soldering inspection system of seventh embodiment of the present invention.

FIG. 16 is a schematic diagram showing system constitution involved in a review station of eighth embodiment of the present invention.

FIG. 17 illustrate schematically a top view, a front view, a side view, and a perspective view of a solder joint produced between an LSI electrode and a printed pad pattern.

### DETAILED DESCRIPTION OF THE EMBODIMENTS

Prior art of an active vision inspection apparatus with mirror motion was disclosed in Japan Patent Application No. Tokuganhei 11-285067 filed by the inventor.

Following the prior art, the present invention intends to introduce an inspection system for parts-mounted and soldered PCBs wherein angular bird's eye perspective view images are utilized for automatic or visual recognition.

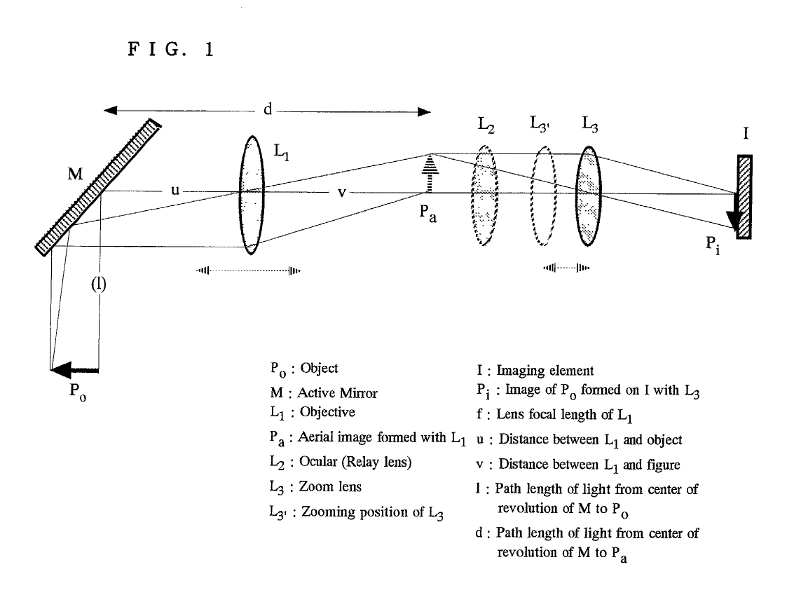

Optical constitution of an active vision system involved in embodiments of the present invention is illustrated schematically in FIG. 1.

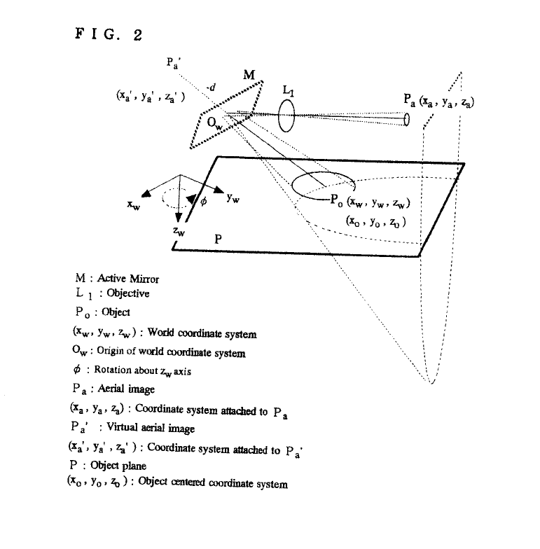

Geometry of the visual axis of the active vision system and an object for inspection is depicted in FIG. 2.

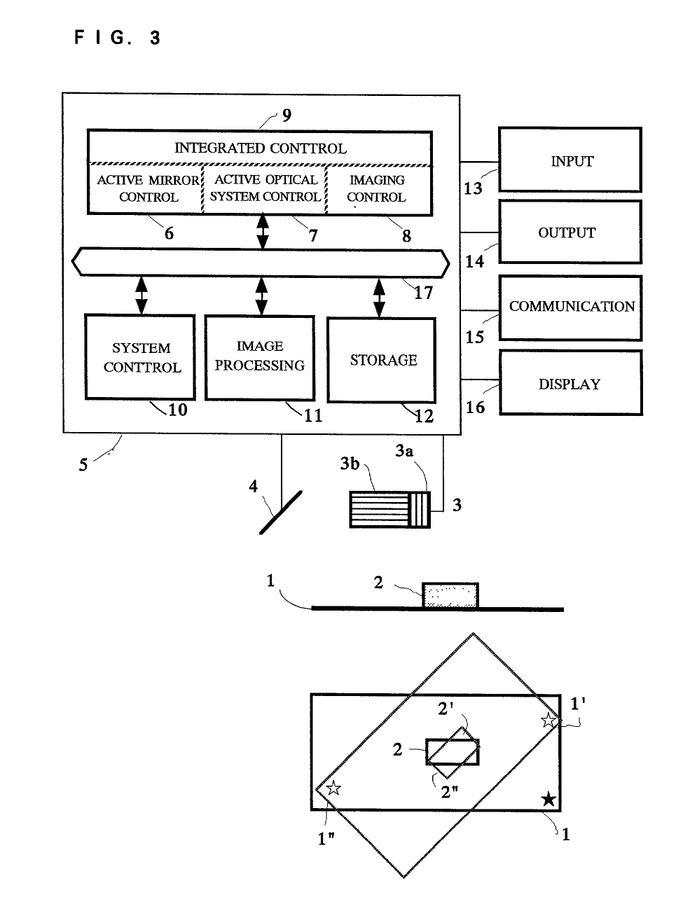

The system constitution and horizontally turned poses of a PCB involved in first embodiment of the present invention are shown schematically in FIG. 3.

Before explaining first embodiment, the reason why that constitution is adopted for the active vision system of the present invention is to be described.

A close-up lens or a microscope objective is generally used for obtaining images with resolution higher than squares of several μm per pixel, but the lens focal length is too short for active vision application wherein the viewing axis should be directed at all directions.

Therefore, embodiments of the present invention are equipped with a telescopic optical system composed of an active objective having long lens focal length and an ocular.

Objective L₁ shown in FIG. 1 is active.

Object Pₒ positions in variable distances.

Focusing at object Pₒ is achieved by moving objective L₁ forward or backward along the optical axis.

Objective L₁ forms aerial figure Pₐ and ocular L₂ relays it to zoom lens L_{3.}

The magnification is adjusted by zooming of zoom lens L₃ and then zoom lens L₃ projects object figure Pᵢ onto imaging element I.

The optical axis is held horizontal and active mirror M is placed in front of objective L_{1.}

Two pivots of revolution (not shown) hold active mirror M so that the extended virtual axes may cross orthogonally each other on the mirror surface.

Active mirror M is deflected in azimuth and/or inclination to point the optical axis at object P_{o.}

The geometrical model is to be mentioned in two steps—the first is a step where objective L₁ forms aerial figure Pₐ and the second is a step where ocular L₂ relays figure P_{a.}

An active vision system using mirror reflection is optically equivalent to a system with an off-set virtual camera rotating around the centroid of the mirror.

FIG. 2 shows an orthogonal coordinate system (xₐ, yₐ, zₐ) attached to aerial figure Pₐ whose origin is the center of the image plane of Pₐ and the zₐ axis is the viewing axis.

As is shown in FIG. 1, the viewing axis is divided into two parts.

A part from object Pₒ to mirror M is ‘active’ in direction and accordingly variable in length.

Another part from mirror M to imaging element I is horizontal and constant in length.

The origin O_{w} of a world coordinate system (x_{w}, y_{w}, z_{w}) is the center of revolution of mirror M.

The x_{w} axis is horizontal and vertical to the y_{w} axis which is parallel to the horizontal optical axis.

The z_{w} axis is perpendicular and object plane P is held horizontal.

Rotation of the normal to mirror M by angle φ about the z_{w} axis produces azimuth deflection of the viewing axis by angle 2φ.

Rotation of the normal to mirror M by angle θ about the x_{w} axis produces inclination deflection of the viewing axis by angle 2θ.

Assuming that light from object Pₒ goes straightforward across the origin O_{w} with no mirror reflection, we image virtual aerial image Pₐ′ at zₐ′=−d that is equivalent to aerial image P_{a.}

Motion of active mirror M produces rotation of the normal about the respective axes of the world coordinate system as expressed in a virtual coordinate system (xₐ′, yₐ′, zₐ′) which is attached to virtual image Pₐ (Expression 1);

Expression 1

$$( \begin{matrix}{x}_{a}^{′} \\ {y}_{a}^{′} \\ {z}_{a}^{′}\end{matrix} ) = {R}_{θ} {R}_{ϕ} {R}_{φ} ( \begin{matrix}{x}_{w} \\ {y}_{w} \\ {z}_{w}\end{matrix} ) + ( \begin{matrix}0 \\ 0 \\ d\end{matrix} )$$

$${R}_{θ} = ( \begin{matrix}1 & 0 & 0 \\ 0 & cos 2 θ & - sin 2 θ \\ 0 & sin 2 θ & cos 2 θ\end{matrix} )$$

$${R}_{ϕ} = ( \begin{matrix}1 & 0 & 0 \\ 0 & 1 & 0 \\ 0 & 0 & 1\end{matrix} )$$

$${R}_{φ} = ( \begin{matrix}cos 2 φ & - sin 2 φ & 0 \\ sin 2 φ & cos 2 φ & 0 \\ 0 & 0 & 1\end{matrix} ) \\$$

(x_{w}, y_{w}, z_{w}): The world coordinate system

(xₐ, yₐ, zₐ): The virtual aerial image coordinate system

R_{θ}: Rotation matrix about the x_{w} axis

R_{φ}: Rotation matrix about the y_{w} axis

R_{φ}: Rotation matrix about the z_{w} axis,

where R_{θ}, R_{φ}, R_{φ} are the rotation matrices about the x_{w} axis, about the y_{w} axis, and about the z_{w}, axis, respectively.

As is shown in FIG. 2, the aperture of objective L₁ produces a visual cone around the viewing axis, projecting an elliptic view field onto object plane P.

Azimuth angle or inclination angle θ of active mirror M moved so as to point the viewing axis at a world coordinate point (x_{w}, y_{w}, z_{w}) is given in the following Expression 2.

Expression 2

$$\begin{matrix}φ = \frac{1}{2} arctan \frac{{x}_{w}}{{y}_{w}} \\ θ = \frac{1}{2} arctan \frac{{y}_{w}}{{z}_{w}}\end{matrix}$$

Moving active mirror M only in azimuth under fixed inclination forms a circular cone of the viewing axis in the world coordinate system whose vertex is the origin O_{w} and the axis is the y_{w} axis.

As the result, changes in azimuth by angle φ about the z_{w} axis for a given inclination angle θ draw a conic section on object plane P

The viewing angle α pointing to object Pₒ is given in the following Expression 3, where h is the vertical distance from the origin O_{w} to object plane P and l is the path length from the origin O_{w} to object P_{o.}

The locus on P is a hyperbola because P is parallel to the axis of the circular cone.

Expression 3

$$\begin{matrix}α = arctan \frac{\sqrt{{x}_{w}^{2} + {y}_{w}^{2}}}{h} \\ {z}_{w} = h \\ l = \sqrt{{x}_{w}^{2} + {y}_{w}^{2} + {h}^{2}}\end{matrix}$$

Expression 4 is the lens formula of objective L₁, where u is the distance to the object point, v is the distance to the image point, and f is the lens focal length shown in FIG. 1.

Expression 4

$$\frac{1}{u} + \frac{1}{v} = \frac{1}{f}$$

In accordance with perspective projection, magnification mₐ of aerial image Pₐ or magnification mₐ′ of virtual aerial image Pₐ′ is given in Expression 5.

Expression 5

$${m}_{a} = {m}_{a}^{′} = \frac{v}{u}$$

Light from ocular L₂ passes through zoom lens L₃ and hits the surface of imaging element I as is shown in FIG. 1.

Many reports on calibration of zoom lenses have accorded in a point that the lens model depends upon its special lens constitution including the distance to the image point.

As for a model of zoom lens L₃, embodiments of the present invention utilize an empirical function obtained from experiments on magnifications and zooming pulses required therefor.

In embodiments of the present invention, magnification mₐ of aerial image Pₐ vanes m accordance with the distance to the object point, u.

To attain constant magnification mᵢ

which is to be irrespective of the focal length, the zooming magnification m_{b} is automatically adjusted according to the original magnification mₐ (Expression 6).

Expression 6

mₐm=mₗ=const.

Thus, the active vision system of the present invention is able to acquire “bird's eye perspective views” of object Pₒ by looking down at Pₒ present on object plane P

Next, the object pose is to be mentioned.

When object Pₒ turns about the axes of an object centered coordinate system (xₒ, yₒ, zₒ) by respective angles ξ, η, and ζ, rotations about the corresponding axes of the world coordinate system are given in the respective rotation matrices of R_{ξ}, R_{η}, and R_{ζ} (Expression 7).

Expression 7

$$( \begin{matrix}{x}_{o} \\ {y}_{o} \\ {z}_{o}\end{matrix} ) = {R}_{ξ} {R}_{η} {R}_{ζ} ( \begin{matrix}{x}_{w} \\ {y}_{w} \\ {z}_{w}\end{matrix} ) + ( \begin{matrix}0 \\ 0 \\ - l\end{matrix} ) , \\ {R}_{ξ} = ( \begin{matrix}1 & 0 & 0 \\ 0 & cos ξ & - sin ξ \\ 0 & sin ξ & cos ξ\end{matrix} )$$

$${R}_{η} = ( \begin{matrix}cos η & 0 & sin η \\ 0 & 1 & 0 \\ - sin η & 0 & cos η\end{matrix} )$$

$${R}_{ζ} = ( \begin{matrix}cos ζ & - sin ζ & 0 \\ sin ζ & cos ζ & 0 \\ 0 & 0 & 1\end{matrix} ) \\$$

Therefore, the object's orientation with respect to the view angle of the active vision system is expressed in Expression 8.

Expression 8

$$( \begin{matrix}{x}_{a}^{′} \\ {y}_{a}^{′} \\ {z}_{a}^{′}\end{matrix} ) = {R}_{0} {R}_{ϕ} {R}_{φ} {R}_{ξ}^{T} {R}_{η}^{T} {R}_{ζ}^{T} ( \begin{matrix}{x}_{o} \\ {y}_{o} \\ {z}_{o}\end{matrix} ) + ( \begin{matrix}0 \\ 0 \\ d - l\end{matrix} )$$

(x_{w}, y_{w}, z_{w}): The world coordinate system

(xₒ, yₒ, zₒ): The object coordinate system

R_{ξ}: Rotation matrix about the x_{w} axis

R_{η}: Rotation matrix about y_{w} axis

R_{ζ}: Rotation matrix about z_{w} axis

Expression 8 gives a general relationship between a viewing angle of an active vision system and an object pose. A three-dimensional object exhibits its external feature better or worse depending upon its pose with respect to the viewer.

In embodiments of the present invention, the stage is equipped with a PCB pose controller able to set a PCB in a pose presenting angular appearances of part electrodes where solder joints may expose themselves best to the vision system.

For inspection of a PCB mounted with comparatively flat parts such as LSIs or chips, the stage is equipped with a turntable.

A PCB which is carried in from a manufacturing line is turned with the turntable horizontally about the centroid of the PCB.

The turn as shown in FIG. 3 is given in ζ rotation of Expression 7. Angles of turn in usual inspection status are ξ=η=0° and ζ=0°, or −135°.

The turned PCB presents an “angular perspective view” of a part including front and side scenes of the electrode(s).

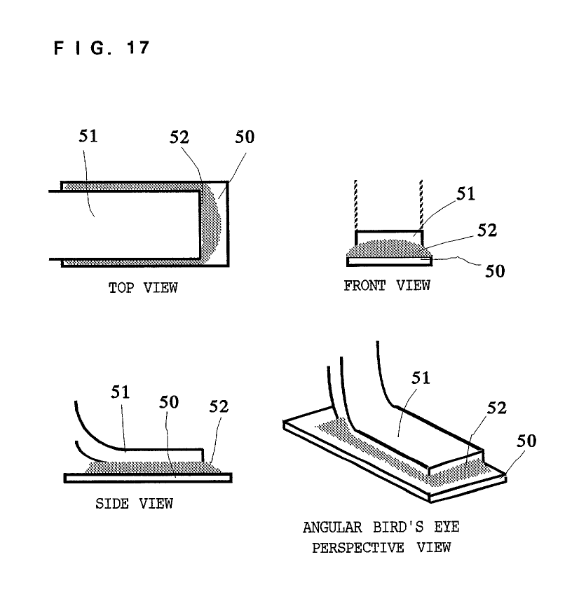

Combination of a bird's eye perspective view with an angular view of an electrode in embodiments of the present invention composes an angular bird' eye perspective view as is given in Expression 8 wherein the top, the front, and the side planes are seen at once (see FIG. 17).

A study of information theory on polyhedral objects has proved that an image of a cube obtained in a direction viewing most planes with nearly uniform areas gives its maximal morphological information.

Most electrodes of surface mount parts are cubical in shape.

Therefore, morphological information of a soldered electrode image is also maximal in an angular bird's eye perspective view.

Appearance of the front solder or the side solder reflects quantity, wettability, or a lifted lead and that of the top solder reflects excess solder or abnormal soldering.

Next, a device for illuminating a PCB during inspection is to be mentioned.

As the view axis is active and the PCB pose and position are variable, embodiments of the present invention are equipped with white light sources widely distributed over the PCB so as to catch lights reflected spectrally from solder surfaces on the PCB.

As for teaching PCB information, inspection point addresses are taught utilizing part-mount address data, part shape data, and computer aided design (CAD) data.

Also are taught the centroid of the PCB and its poses during inspection.

Next, layout of inspection areas is to be mentioned.

Embodiments of the present invention are equipped with a program for layout of inspection areas.

Using part-mount and soldering point addresses of a PCB, pleural soldering points are automatically grouped in an inspection area, which is then enclosed with a rectangular frame.

The active vision system images the inspection area and displays it on a monitor screen.

The rectangular frame is metamorphosed into a trapezoid in accordance with Expression 8 for real angular bird's eye transformation, and then it is superimposed on the displayed real image.

Watching the screen, an operator manually modifies the trapezoidal area to obtain suitable size and shape.

Next, evaluating soldering quality is to be mentioned.

An inspection system of an embodiment of the present invention carries a program for automatically extracting inspection points, a program for orthogonal transformation of perspective images, a program for calculating discriminative parameters used for evaluating part-mount and soldering quality, and an algorithm for evaluation.

In the teaching mode, an embodiment of the present invention automatically extracts inspection points by processing inspection area image signals.

In the inspection mode, an embodiment of the present invention morphs perspective images of the inspection points into orthogonal style images and calculates discriminative parameters therefrom.

Then, an embodiment of the present invention evaluates part-mount and soldering quality by feeding the discriminative parameters into the algorithm for evaluation.

Based on the evidences mentioned above, constitution and performance of a multi-modal soldering inspection system of an embodiment of the present invention are to be described referring to a schematic diagram showing system constitution (FIG. 3) and schematic illustrations depicting PCB poses with respect to the viewing angle.

FIG. 3 demonstrates PCB 1 and electronic part 2 mounted thereon.

PCB 1 is held with a stage which is equipped with a turntable (not shown). In top views shown below the side view in FIG. 3, PCB 1 denotes an original pose, PCB 1′ denotes a pose after horizontal turn by 45°, and PCB 1″ denotes a pose after horizontal turn by −135°.

Active vision system 3 and active mirror 4 are positioned over PCB 1. Active vision system 3 is composed of imaging device 3a and active optical system 3b.

Active vision system 3 and active mirror 4 are connected to control system 5 which consists of subunit 6 for active mirror control, subunit 7 for active lens system control, subunit 8 for imaging control, unit 9 for integrated control of subunits 6˜8, unit 10 for control of the total system, unit 11 for image processing, and unit 12 for storage.

Units 9, 10, 11, and 12 interact each other via bus 17.

Control system 5 is connected to input unit 13, output unit 14, communication unit 15, and display unit 16.

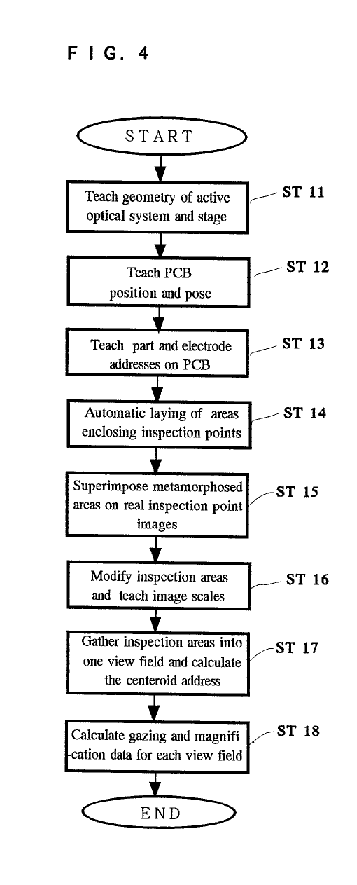

Steps of teaching are to be mentioned according to a flow diagram shown in FIG. 4.

First, an operator teaches the geometry of active optical system 3b and the stage (not shown) (ST 11) and also the position and the pose of the PCB (ST 12). Next, utilizing part mount data, part shape data, or PCB CAD data, he/she teaches the addresses to which parts are to be mounted and the electrode addresses corresponding to soldering inspection points (ST 13).

An inspection system of an embodiment of the present invention automatically gathers several inspection points of a part into an inspection area and encloses it with a rectangular frame (ST 14).

An embodiment then captures an image of the area and displays it on a monitor screen.

By calculating view-angle dependent perspective transformation, an embodiment of the present invention automatically metamorphoses the rectangular frame into a trapezoid with corresponding angular bird's eye perspective shape and superimposes it on the real inspection area image (ST 15).

Watching the real inspection point images, the operator manually modifies size and shape of the superimposed trapezoid and then teaches magnification for imaging (ST 16).

After gathering several inspection areas into one view field, an embodiment of the present invention calculates the centroid address of the view field (ST 17) and also the gaze control data and the magnification data for the view field (ST 18).

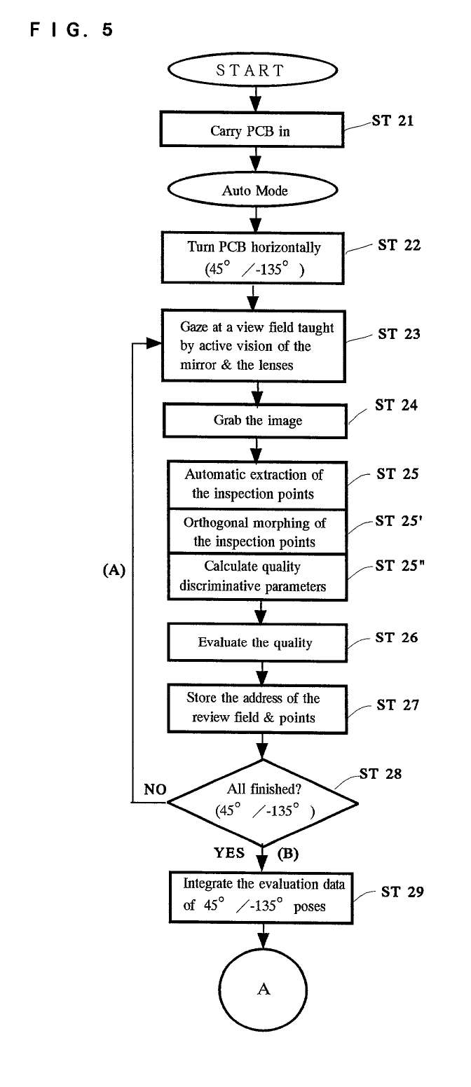

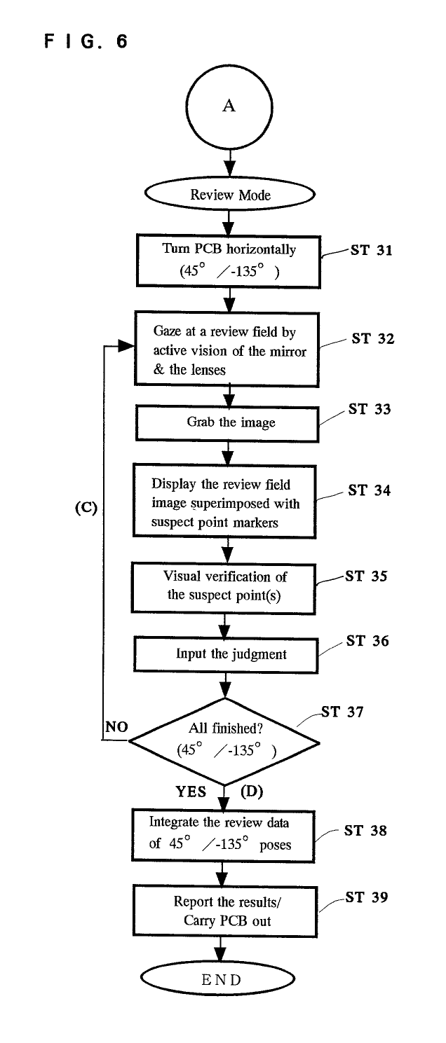

Steps of automatic inspection in auto mode are to be mentioned along a flow diagram of FIG. 5 and steps of verification by watching displayed suspect point images in the following review mode are to be explained along a flow diagram of FIG. 6.

After the PCB is carried in (ST 21) and auto mode is selected, the stage chucks the PCB and turns it by horizontal angle 45° about the centroid (ST 22) (see PCB 1′ and electronic part 2′ shown in FIG. 3).

An inspection system of an embodiment of the present invention gazes at a view field taught in the teaching steps by moving active mirror 4 to point the optical axis at the field, by translating active objective L₁ to focus thereon, and by zooming zoom lens L₃ to adjust magnification (ST 23). Then an embodiment grabs the view field image (ST 24), automatically extracts the inspection points within each inspection area (ST 25), morphs the perspective image into an orthogonal style (ST 25′), calculates the discriminative parameters for each point (ST 25″), evaluates part-mount and soldering quality of each point (ST 26), and stores the addresses of the view field and suspect points to be reviewed subsequently (ST 27).

When inspection of all inspection areas in the 45° turn pose was finished, the system turns the PCB by horizontal angle −135° (see PCB 1″ and electronic part 2″ shown in FIG. 3) and performs inspection again over all inspection areas (ST 23˜ST 27).

When inspection of all inspection areas is accomplished in the 45° and −135° poses, ST 28 turns into YES. Then an embodiment integrates the evaluation data for every inspection point in both poses (ST 29).

Next, review mode is selected as is shown in FIG. 6.

The stage turns the PCB by horizontal angle 45° about the centroid (ST 31).

An embodiment of the present invention gazes at a review field enclosing suspect points by moving active mirror 4 to point the optical axis at the field, by translating active objective L₁ to focus thereon, and by zooming zoom lens L₃ to adjust magnification (ST 32).

Then an embodiment grabs the view field image (ST 33), displays the suspect point images, and superimposes markers thereon (ST 34). An operator performs verification by looking at the displayed suspect point images (ST 35) and inputs the judgment (ST 36).

When inspection of all inspection areas in the 45° pose was finished, the system turns the PCB by horizontal angle −135° and performs the review steps again over all review areas (ST 32˜ST 36). When inspection of all review areas is accomplished in the 45° and −135° poses, ST 37 turns into YES.

Then an embodiment integrates the review data for every suspect point in both poses (ST 38).

Finally, an embodiment reports the results and carries out the PCB (ST 39).

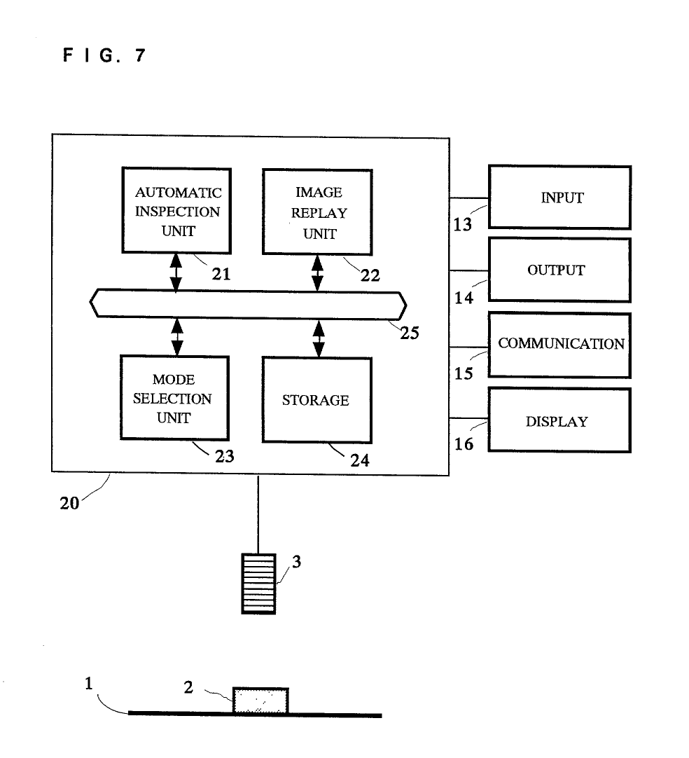

Constitution of an inspection system of second embodiment of the present invention and a posed PCB are schematically demonstrated in FIG. 7. The figure illustrates soldered electronic parts 2 mounted on PCB 1 and an imaging unit 3 placed upward of the PCB.

Imaging unit 3 is connected to control system 20 which consists of automatic inspection unit 21, image replay unit 22, mode selection unit 23, and storage 24.

Units 21˜23 and storage 24 communicate each other via bus 25. Control system 20 is connected with input unit 13, output unit 14, communication unit 15, and display unit 16.

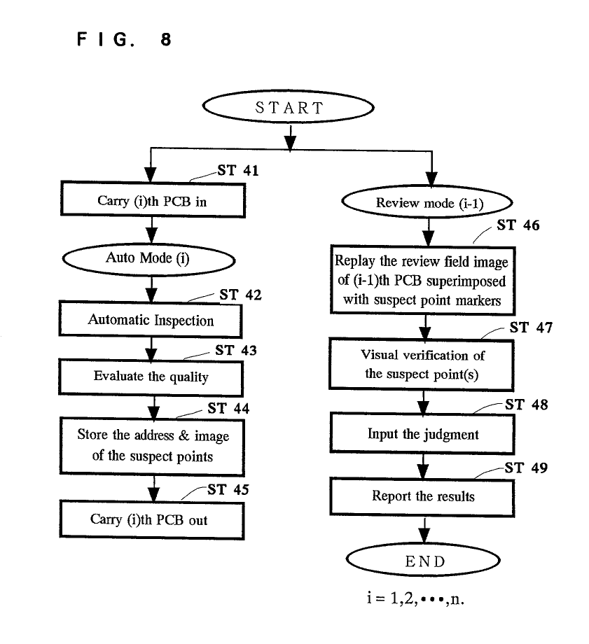

Parallel action of auto mode and review mode of second embodiment is to be mentioned in accordance with a flow diagram of FIG. 8.

After the PCB is carried in (ST 41) and auto mode is selected for (i)th PCB, imaging unit 3 grabs images of the PCB and automatic inspection unit 21 performs automatic inspection of the inspection points thereof (ST 42), evaluates the package quality (ST 43), and stores the address and the image of the view field including suspect points to be reviewed subsequently (ST 44).

After all the points were inspected, the embodiment carries out (i)th PCB (ST 45).

In parallel with the auto mode of (i)th PCB mentioned above, second embodiment simultaneously performs review mode inspection of (i-1)th PCB. The embodiment replays the stored review field images and superimposes markers on suspect point images (ST 46).

An operator performs verification by looking at the replayed suspect point images (ST 47) and inputs the judgment (ST 48).

Then the embodiment reports the total inspection results (ST 49).

A multi-modal soldering inspection system of third embodiment of the present invention is to be described.

Constitution of an inspection system of third embodiment and the position and pose of a PCB are similar to those of first embodiment shown in FIG. 3.

Because hardware constitution of the active vision system of third embodiment and steps of teaching are also quite similar to those of first embodiment, explanation is to be omitted.

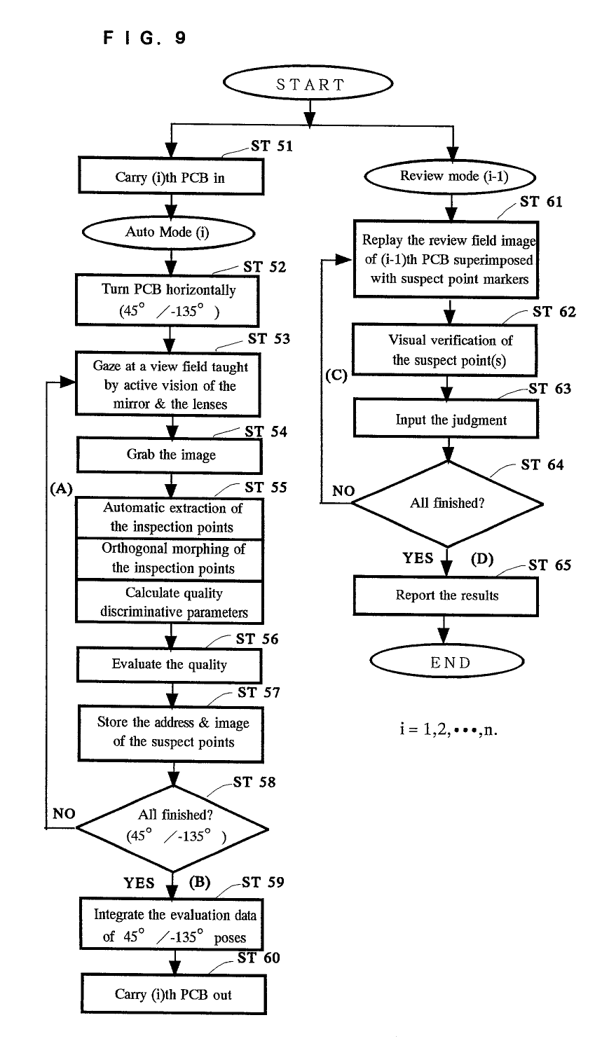

Third embodiment performs review mode inspection in parallel with auto mode inspection by means of system control unit 10 shown in FIG. 3. The performance is denoted in a flow diagram of FIG. 9.

After the (i)th PCB is carried in (ST 51) and auto mode is selected, the stage chucks the PCB and turns it by horizontal angle 45° about the centroid (ST 52).

An inspection system of third embodiment of the present invention gazes at a view field taught in the teaching steps by moving active mirror 4 to point the optical axis at the field, by translating active objective L₁ to focus on there, and by zooming zoom lens L₃ to adjust magnification (ST 53).

Then the embodiment grabs the view field image (ST 54), automatically extracts the inspection points within each inspection area, morphs the perspective image into an orthogonal style, calculates the discriminative parameters for each point (ST 55), evaluates part-mount and soldering quality of each point (ST 56), and stores the address and the image of the view field including suspect points to be reviewed subsequently (ST 57).

When inspection of all inspection areas in the 45° turn pose was finished, the system turns the PCB by horizontal angle −135° and performs inspection again over all inspection areas (ST 53˜ST 57). When inspection of all inspection areas is accomplished in the 45° and −135° poses, ST 58 turns into YES.

Then third embodiment integrates the evaluation data for every inspection point in both poses (ST 59) and carries out (i)th PCB (ST 60).

In parallel with the auto mode of (i)th PCB mentioned above, third embodiment simultaneously performs review mode inspection of (i-1)th PCB.

The embodiment replays the stored review field images and superimposes markers on suspect point images (ST 61).

An operator performs verification by looking at the replayed suspect point images (ST 62) and inputs the judgment (ST 63). When all the inspection is finished, ST 64 turns into YES and then the embodiment reports the total inspection results of (i-1)th PCB (ST 65).

Next, a multi-modal soldering inspection system of fourth embodiment of the present invention is to be described.

Constitution of an inspection system of fourth embodiment and the position and pose of a PCB are similar to those of second embodiment shown in FIG. 7.

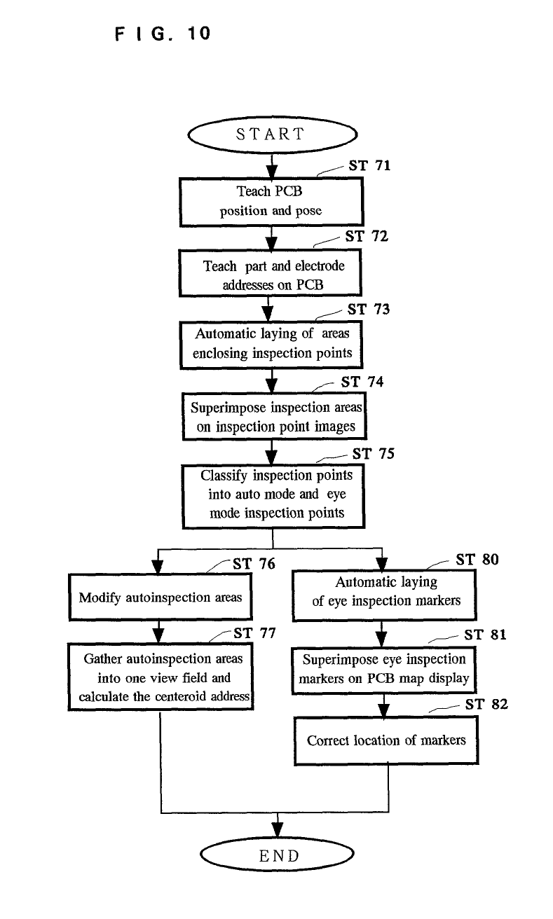

Steps of teaching of forth embodiment are denoted in a flow diagram of FIG. 10.

First, an operator teaches the position and the pose of the PCB (ST 71). Next, utilizing part mount data, part shape data, or PCB CAD data, he/she teaches the addresses to which parts are to be mounted and the electrode addresses corresponding to soldering inspection points (ST 72). An inspection system of fourth embodiment of the present invention automatically gathers several inspection points of a part into an inspection area and encloses it with a frame (ST 73).

Fourth embodiment then captures an image of the area, displays it on a monitor screen, and superimposes the frame on the real inspection area image (ST 74).

An operator classifies all the inspection points into auto mode inspection points or eye mode inspection points (ST 75).

Inspection points occluded or shaded by tall parts will not present good images for automatic recognition.

Therefore they are classified into eye mode inspection points.

On the other hand, inspection points without occlusion or shading will present good images for automatic detection of flaw soldering. Therefore they are classified into auto mode inspection points.

The classification of inspection points will eliminate time-consuming laborious tuning-up of recognition capability for difficult points and will also save total inspection cost efficiently.

Then the operator manually modifies size and shape of the superimposed frame (ST 76).

After gathering several inspection areas into one view field, fourth embodiment of the present invention calculates the centroid address of the view field (ST 77).

For eye mode inspection points, the embodiment automatically lays eye inspection markers (ST 80), superimposes them on a PCB parts-mount map (ST 81).

The operator corrects location of the markers (ST 82).

Fourth embodiment performs auto mode and review mode at the same time under the control of mode selection unit 23 in FIG. 7.

The embodiment permits the operator to execute eye mode inspection of a preceding PCB.

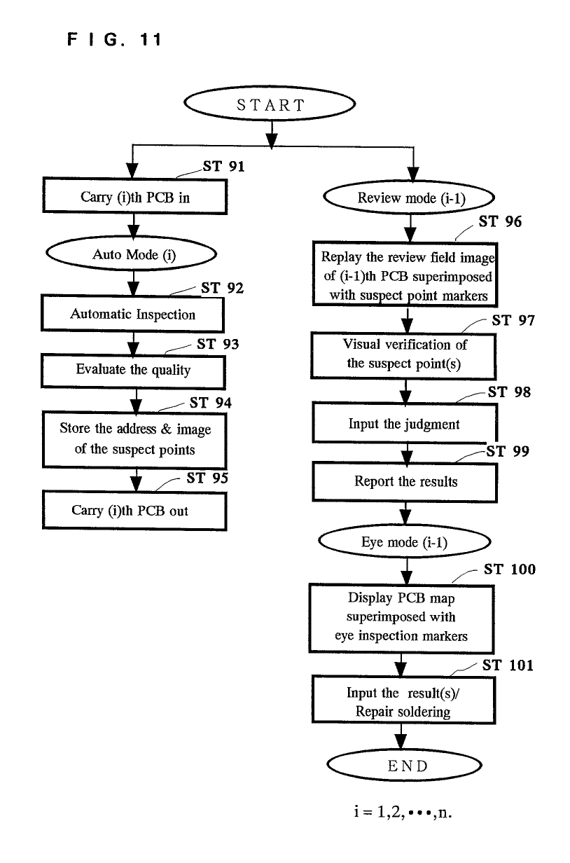

The three-modal inspection is to be mentioned in accordance with a flow diagram of FIG. 11.

After (i)th PCB is carried in (ST 91) and auto mode is selected, imaging unit 3 grabs images of the PCB 1 and automatic inspection unit 21 caries out automatic inspection of the inspection points thereof (ST 92), evaluates the package quality (ST 93), and stores the address and the image of the view field including suspect points to be reviewed subsequently (ST 94). After all the points were inspected, the embodiment carries out (i)th PCB (ST 95).

In parallel with the auto mode of (i)th PCB mentioned above, fourth embodiment simultaneously performs review mode inspection of (i-1)th PCB.

The embodiment replays the stored review field images and superimposes markers on suspect point images (ST 96).

An operator performs verification by looking at the replayed suspect point images (ST 97) and inputs the judgment (ST 98).

Then the embodiment reports the inspection results (ST 99).

Next, the embodiment turns into eye mode of (i-1)th PCB, displays a PCB parts-mount map, and superimposes eye inspection point markers on it (ST 100).

The operator conducts visual inspection of the eye inspection points by referring to the map and inputs the results and/or repairs faulty solder joints (ST 101).

A multi-modal soldering inspection system of fifth embodiment of the present invention is to be mentioned.

Constitution of an inspection system of fifth embodiment and the position and pose of a PCB are similar to those of first embodiment shown in FIG. 3.

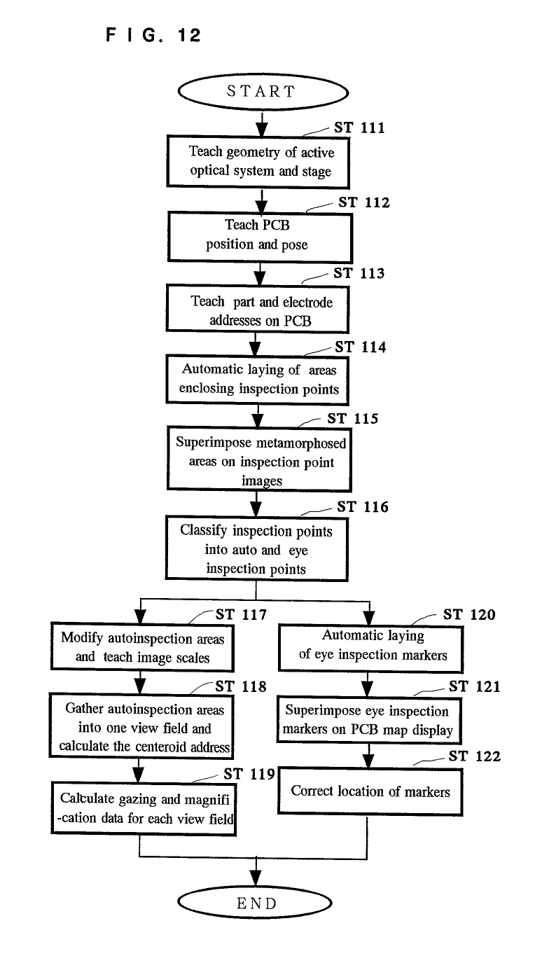

Steps of teaching are to be mentioned according to a flow diagram shown in FIG. 12

First, an operator teaches the geometry of active optical system 3b and the stage (not shown) (ST 111) and also the position and the pose of the PCB (ST 112).

Next, utilizing part mount data, part shape data, or PCB CAD data, he/she teaches the addresses to which parts are to be mounted and the electrode addresses corresponding to soldering inspection points (ST 113). An inspection system of fifth embodiment of the present invention automatically gathers several inspection points into an inspection area and encloses it with a rectangular frame (ST 114).

Fifth embodiment then captures an image of the area and displays it on a monitor screen.

By calculating view-angle dependent perspective transformation, an embodiment of the present invention automatically metamorphoses the rectangular frame into a trapezoid with corresponding angular bird's eye perspective shape and superimposes it on the real inspection area image (ST 115).

An operator classifies all the inspection points into auto mode inspection points and eye mode inspection points (ST 116).

Inspection points occluded or shaded by tall parts will not present good images for automatic recognition.

Therefore they are classified into eye mode inspection points.

On the other hand, inspection points without occlusion or shading will present good images for automatic detection of flaw soldering. Therefore they are classified into auto mode inspection points.

The classification of inspection points will eliminate time-consuming laborious tuning-up of recognition capability for difficult points and will also save total inspection cost efficiently.

Then the operator manually modifies size and shape of the superimposed trapezoid and then teaches magnification for imaging (ST 117).

After gathering several inspection areas into one view field, fifth embodiment of the present invention calculates the centroid address of the view field (ST 118) and also the gaze control data and the magnification data for the view field (ST 119).

For eye mode inspection points, the embodiment automatically lays eye inspection markers (ST 120), superimposes them on a PCB parts-mount map (ST 121).

The operator corrects location of the markers (ST 122).

Fifth embodiment performs auto mode and review mode at the same time under the control of system control unit 10 in FIG. 3.

The embodiment permits the operator to execute eye mode inspection of a preceding PCB.

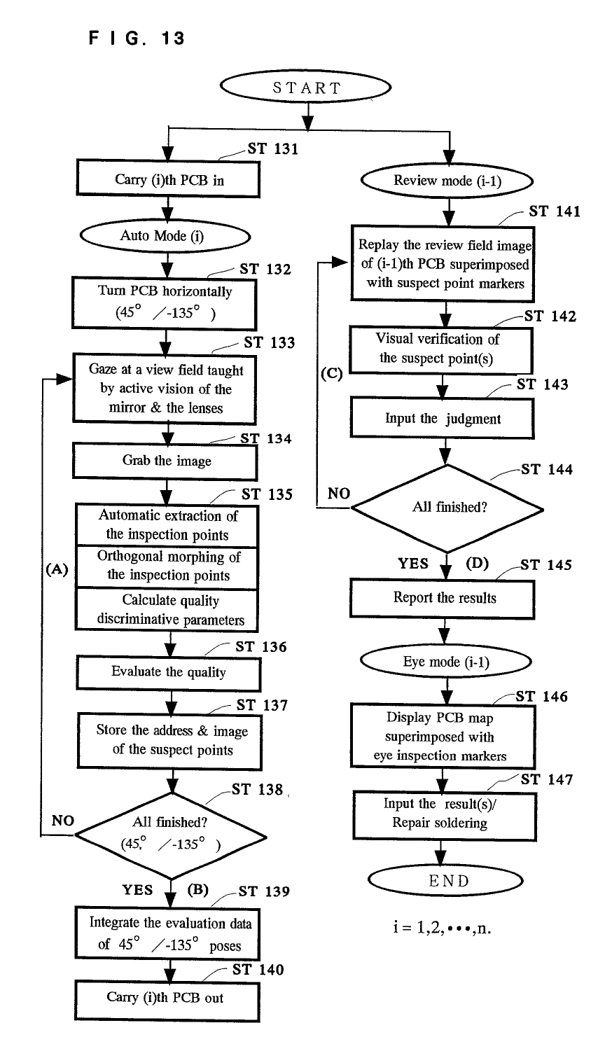

The three-modal inspection is to be mentioned in accordance with a flow diagram of FIG. 13.

After the (i)th PCB is carried in (ST 131) and auto mode is selected, the stage chucks the PCB and turns it by horizontal angle 45° about the centroid (ST 132).

An inspection system of fifth embodiment of the present invention gazes at a view field taught in the teaching steps by moving active mirror 4 to point the optical axis at the field, by translating active objective L₁ to focus on there, and by zooming zoom lens L₃ to adjust magnification (ST 133).

Then the embodiment grabs the view field image (ST 134), automatically extracts the inspection points within each inspection area, morphs the perspective image into an orthogonal style, calculates the discriminative parameters for each point (ST 135), evaluates part-mount and soldering quality of each point (ST 136), and stores the address and the image of the view field including suspect points to be reviewed subsequently (ST 137).

When inspection of all inspection areas in the 45° turn pose was finished, the system turns the PCB by horizontal angle −135° and performs inspection again over all inspection areas (ST 133˜ST 137). When inspection of all inspection areas is accomplished in the 45° and −135° poses, ST 138 turns into YES.

Then fifth embodiment integrates the evaluation data for every inspection point in both poses (ST 139) and carries out (i)th PCB (ST 140).

In parallel with the auto mode of (i)th PCB mentioned above, fifth embodiment simultaneously performs review mode inspection of (i-1)th PCB.

The embodiment replays the stored review field images and superimposes markers on suspect point images (ST 141).

An operator performs verification by looking at the replayed suspect point images (ST 142) and inputs the judgment (ST 143).

When all the inspection is finished, ST 144 turns into YES and then the embodiment reports the total inspection results of (i)th PCB (ST 145).

Next, the embodiment turns into eye mode of (i-1)th PCB, displays a PCB parts-mount map, and superimposes eye inspection point markers on it (ST 146).

The operator conducts visual inspection of the eye inspection points by referring to the map and inputs the results and/or repairs faulty solder joints (ST 147).

A multi-modal soldering inspection system of sixth embodiment of the present invention is to be described.

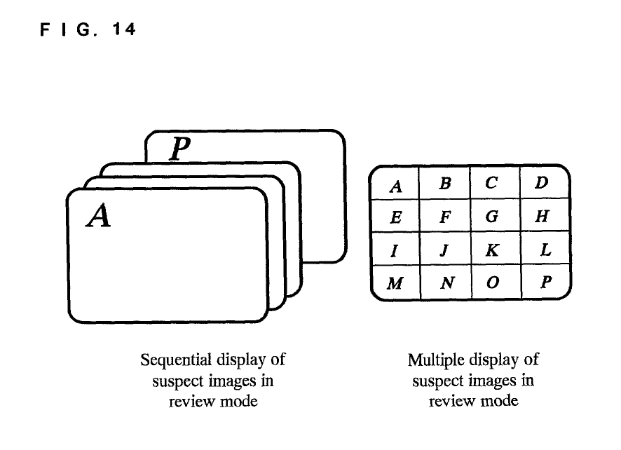

As are depicted in FIG. 14, sixth embodiment, in the review mode inspection, is able to display suspect point images not only in a sequential, one-by-one fashion but also in a multiple-frame fashion demonstrating several images simultaneously.

An inspector is able to select one-by-one display for precise observation of suspect images or multiple-image display for quick verification.

A multi-modal soldering inspection system of seventh embodiment of the present invention is to be mentioned.

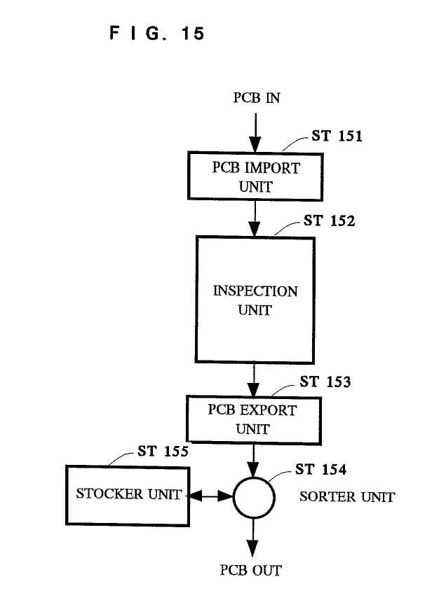

As are shown in FIG. 15, seventh embodiment is equipped with PCB import unit 151 for carrying PCBs in, inspection unit 152 for auto mode inspection, PCB export unit 153 for carrying them out, sorter 154 for sorting PCBs with suspect points and/or eye inspection points, and stocker unit 155 for storing them for review or eye mode inspection.

The embodiment enables in-line auto mode inspection, out-line review mode inspection of stored PCBs having suspect points, and eye mode inspection of stored PCBs having eye inspection points.

A review station of eighth embodiment of the present invention is to be described.

Eighth embodiment is a station which is able to be placed anywhere apart from a multi-modal soldering inspection system and enables review mode inspection or eye mode inspection without using the inspection system itself

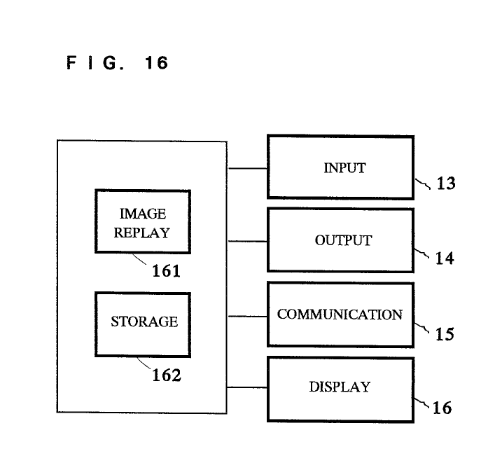

As are illustrated in FIG. 16, eighth embodiment is equipped with image replay unit 161, storage 162, input unit 13, output unit 14, communication unit 15, and display unit 16.

The embodiment is able to receive addresses and images of suspect points of a PCB from a multi-modal soldering inspection system of the present invention and replays the suspect images superimposed with suspect point markers.

The embodiment enables an operator to perform review mode inspection by watching the replayed images.

The embodiment is also able to receive eye inspection data from a multi-modal soldering inspection system of the present invention and displays a PCB map superimposed with eye inspection point markers. The embodiment enables an inspector to perform eye mode inspection by referring to the PCB map.

What is claimed is:

1. A multi-modal soldering inspection system which works in two modes wherein, in auto mode, the system performs automatic inspection of solder joints of a printed circuit board (PCB) and stores addresses of suspect points which have been tentatively judged as defective in the automatic inspection and, in review mode, the system reacquires images of the suspect points and display them with markers superimposed thereon so that an operator can carry out the verification by looking at the displayed images and accomplish the total inspection by inputting the reviewed data comprising:
means for automatic inspection involving imaging means for imaging solder joints;
mode-selecting means for selecting the auto mode or the review mode;
means for integrating inspection data obtained in the auto and the review modes;
storage for storing the inspection data;
display means for displaying images reacquired with the imaging means; and
input means for inputting the reviewed data.

2. A multi-modal soldering inspection system which works in two modes wherein, in auto mode, the system performs automatic inspection of solder joints of a PCB and stores images and addresses of suspect points which have been tentatively judged as defective in the automatic inspection and, in review mode, the system replays the stored images and display them with markers superimposed thereon so that an operator can carry out the verification by looking at the displayed images and accomplish the total inspection by inputting the reviewed data comprising:
means for automatic inspection involving imaging means for imaging solder joints;
mode-selecting means for selecting the auto mode or the review mode;
means for integrating inspection data obtained in the auto and the review modes;
storage for storing the inspection data;
replay means for replaying images stored with the storage means and display them; and
input means for inputting the reviewed data.

3. A multi-modal soldering inspection system which works in three modes wherein, in auto mode, the system performs automatic inspection of solder joints of a PCB and stores images and addresses of suspect points which have been tentatively judged as defective in the automatic inspection, in review mode, the system replays images of the suspect points and display them with markers superimposed thereon so that an operator can carry out the verification by looking at the images and input the reviewed data, and, in eye mode, the system displays a PCB map indicating addresses of points for visual inspection so that an operator can carry out direct visual inspection of the PCB referring to the map and accomplish the total inspection by inputting the visual inspection data comprising:
means for automatic inspection involving imaging means for imaging solder joints;
mode-selecting means for selecting the auto mode, the review mode, or the eye mode;
means for integrating inspection data obtained in the auto and the review modes;
storage for storing the inspection data:
replay means for replaying images stored with the storage means and display them; and
input means for inputting the reviewed data and the visual inspection data.

4. The multi-modal soldering inspection system set forth in claim 1, claim 2, or claim 3 which utilizes perspective view images obtained with coordinated operations of an active vision system and a turntable comprising:
an active optical system for bird's eye perspective viewing of solder joints joining electronic parts with a printed circuit;
a turntable able to turn a PCB in such a direction that said active optical system may have angular perspective views of the electronic parts and the solder joints on the PCB;
teaching means for teaching the positions and the poses of the PCB during inspection and also the addresses of the electronic parts and the part's electrodes on the PCB;
means for making an inspection program including layout of the inspection areas enclosing several inspection points;
imaging means including said active optical system;
means for coordinating operations of said active optical system and said turntable so that said imaging means may acquire angular bird's eye perspective view images of the inspection points on the PCB; and
means for automatically evaluating part-mounting and soldering quality using the inspection point images acquired therewith.

5. The multi-modal soldering inspection system set forth in claim 1, claim 2, or claim 3 wherein said active optical system is positioned over said turntable so that said means for imaging may acquire bird's eye perspective view images of a PCB and wherein said active optical system is provided with an active mirror device capable of moving a mirror to point the viewing axis at a view field involving inspection areas by mirror reflection according to a command for mirror deflection based on the view field address, with an active telescopic device having an objective and an ocular capable of translating the objective along the viewing axis so as to focus at the view field, forming its aerial figure and relaying it to a subsequent magnification adjuster, according to a command for objective translation based on the view field address, and with a magnification adjuster having a zoom lens capable of adjusting the magnification of the aerial figure into a taught magnification according to a command for magnification adjustment based on the view field address.

6. The soldering inspection system set forth in claim 5 wherein the objective of said active telescopic device is an achromatic lens having long lens focal length.

7. Said active mirror device of the soldering inspection system set forth in claim 5 is provided with a surface mirror, a device for azimuth mirror deflection, and a device for inclination mirror deflection, wherein said device for azimuth mirror deflection is able to turn said surface mirror about an axis of a horizontal pivot holding said surface mirror in such a way that the extended virtual axis may pass the mirror surface, and wherein said device for azimuth mirror deflection is able to turn said device for inclination mirror deflection about an axis of an upright pivot holding device for inclination mirror deflection in such a way that the extended virtual axis may pass the mirror surface in orthogonal crossing with the extended virtual axis of the horizontal pivot of said device for inclination mirror deflection, enabling catadioptric pointing of the viewing axis at a view field involving inspection areas.

8. The multi-modal soldering inspection system set forth in claim 1, claim 2, or claim 3 wherein white light sources are widely distributed over a PCB for illuminating the PCB during inspection.

9. The soldering inspection system set forth in claim 4 wherein said means for making an inspection program is provided with an inspection area laying program to automatically lay out an inspection area so as to involve soldering inspection points and to enclose them with a rectangular frame according to taught data, with a metamorphosing program to metamorphose the rectangular frame into a trapezoidal frame according to the same perspective transformation as the corresponding real image, and with a superimposing program to superimpose the trapezoidal frame on a displayed real inspection area image, enabling manual modification of size and shape of the inspection area.

10. The soldering inspection system set forth in claim 4 wherein said means for evaluating part-mounting or soldering quality is provided with an image-processing program for extracting soldering inspection points from inspection area image signals captured with said imaging means, with a morphing program for orthogonal morphing of perspective inspection point images extracted therewith, with a calculation program for calculating quality discriminative parameters from inspection point image signals, and with an evaluation program for evaluating part-mounting or soldering quality of each inspection point using the quality discriminative parameters.

11. The multi-modal soldering inspection system set forth in claim 2 or claim 3 comprising:
means for parallel inspection wherein said auto mode inspection of the next PCB is carried out in parallel with said review mode image verification and/or said eye mode visual inspection of the present PCB.

12. The multi-modal soldering inspection system set forth in claim 2 or claim 3 comprising:
means for simultaneous multiple display of pleural suspect point images as well as one-by-one sequential display of each suspect point image in said review mode.

13. The multi-modal soldering inspection system set forth in claim 1, claim 2, or claim 3 comprising:
means for carrying a PCB into and out from the inspection system;
means for sorting out PCBs having suspect points and/or points for eye mode visual inspection; and
means for storing PCBs for verification in said review mode and/or in said eye mode visual inspection.

14. A review station which receives the images and the addresses of suspect points and/or the addresses of points for visual inspection of a PCB obtained in said auto mode of the multi-modal soldering inspection system set forth in claim 1, claim 2, or claim 3, performs said review mode wherein the station replays images of the suspect points to display them with markers superimposed thereon so that an operator can carry out the verification by looking at the images and input the review data, and also performs said eye mode wherein the station displays a PCB map indicating addresses of points for visual inspection so that an operator can carry out direct visual inspection of the PCB referring to the map and accomplish the total inspection by inputting the visual inspection data comprising:
means for mutual data communication with said soldering inspection system;
input means for inputting commands for said soldering inspection system;
means for replay and display of images transferred from said soldering inspection system; and
means for storing data transferred from said soldering inspection system.
